(19) United States
(12) Patent Application Publication
(10) Pub. No.: US 2017/0242937 A1
(43) Pub. Date: Aug. 24, 2017

(54) SENSITIVITY ANALYSIS SYSTEMS AND METHODS USING ENTROPY

(71) Applicant: Infineon Technologies AG, Neubiberg (DE)

(72) Inventors: Ingrid Kovacs, Satu Mare (RO); Andi Buzo, Bucharest (RO); Monica Rafaila, Munchen (DE); Georg Pelz, Ebersberg (DE); Marina Dana Topa, Cluj (RO)

(21) Appl. No.: 15/047,860

(22) Filed: Feb. 19, 2016

(51) Int. Cl. G06F 17/50; G06F 17/18

(52) U.S. Cl. CPC G06F 17/5009; G06F 17/18

(57) ABSTRACT

A sensitivity analysis arrangement using entropy is disclosed. The arrangement includes a design of experiments component, a simulation component and an entropy controller. The design of experiments component is configured to generate a set of factors of a response for a device and to generate a design of experiments using the set of factors. The simulation/measurement component is configured to obtain response values for the design of experiments and the set of factors. The entropy controller is configured to determine a set of entropy values for the set of factors and to determine a reduced set of relevant factors based on the set of entropy values. The reduced set of relevant factors is a subset of the factors.

### BACKGROUND

Devices, products and systems typically undergo verification during and/or after production. The verification can be used to assess whether requirements are met, determine failures, characterize the device and the like.

However, the devices, products and systems are continuously growing in complexity. As a result, verification likewise grows in complexity. Thus, the verification and verification processes require substantial costs in terms of time, verification hardware and/or processing power.

Techniques are needed to characterize complex devices, products and systems without requiring substantial time, hardware and/or processing power.

### BRIEF DESCRIPTION OF THE DRAWINGS

FIG. 1 is a block diagram illustrating a device production and verification system.

FIG. 2 is a diagram illustrating a device subjected to sensitivity analysis using entropy.

FIG. 3 is a block diagram of a sensitivity analysis arrangement using entropy.

FIG. 4 is a graph of scatter plots showing response values or samples for various factors and their relationship.

FIG. 5 is a flow diagram illustrating a method of determining a reduced set of relevant factors by performing sensitivity analysis a simple entropy technique.

FIG. 6A is a table illustrating an example of a design of experiments that can be developed.

FIG. 6B is a table illustrating an example of simulations for a design of experiments.

FIG. 6C is a table illustrating an example of entropy values.

FIG. 7 is a flow diagram illustrating a method of determining a reduced set of relevant factors by performing sensitivity analysis using a pair based entropy technique.

### DETAILED DESCRIPTION

The present invention will now be described with reference to the attached drawing figures, wherein reference numerals are used to refer to like elements throughout, and wherein the illustrated structures and devices are not necessarily drawn to scale.

As utilized herein, terms “component,” “system,” “interface,” and the like are intended to refer to a computer-related entity, hardware, software (e.g., in execution), and/or firmware. For example, a component can be a processor (e.g., a microprocessor, a controller, or other processing device), a process running on a processor, a controller, an object, an executable, a program, a storage device, a computer, a tablet PC, an electronic circuit and/or a mobile phone with a processing device. Some other examples of a component include a voltage regulator that provides power for various loads, including loads in automotives, a processor or circuitry in automotive electronics, a processor or circuitry located on a credit card, a switch that drives a valve in an anti-lock braking system (ABS), a switch that drives an electric motor, a pressure sensor, a pressure sensor for an airbag system, a current sensor, a current sensor in an electrical power steering (EPS) system and the like. By way of illustration, an application running on a server and the server can also be a component. One or more components can reside within a process, and a component can be localized on one computer and/or distributed between two or more computers. A set of elements or a set of other components can be described herein, in which the term “set” can be interpreted as “one or more.”

Further, these components can execute from various computer readable storage media having various data structures stored thereon such as with a module, for example. The components can communicate via local and/or remote processes such as in accordance with a signal having one or more data packets (e.g., data from one component interacting with another component in a local system, distributed system, and/or across a network, such as, the Internet, a local area network, a wide area network, or similar network with other systems via the signal).

As another example, a component can be an apparatus with specific functionality provided by mechanical parts operated by electric or electronic circuitry, in which the electric or electronic circuitry can be operated by a software application or a firmware application executed by one or more processors. The one or more processors can be internal or external to the apparatus and can execute at least a part of the software or firmware application. As yet another example, a component can be an apparatus that provides specific functionality through electronic components without mechanical parts; the electronic components can include one or more processors therein to execute software and/or firmware that confer(s), at least in part, the functionality of the electronic components.

As used herein, the term “circuitry” may refer to, be part of, or include an Application Specific Integrated Circuit (ASIC), an electronic circuit, a processor (shared, dedicated, or group), and/or memory (shared, dedicated, or group) that execute one or more software or firmware programs, a combinational logic circuit, and/or other suitable hardware components that provide the described functionality. In some embodiments, the circuitry may be implemented in, or functions associated with the circuitry may be implemented by, one or more software or firmware modules. In some embodiments, circuitry may include logic, at least partially operable in hardware.

A verification level for a device (or devices) is a level or process point where performance and functionality of the device is verified. The verification level can occur at one or more points or levels of production. The device can include, for example, a device, product, system, pre-silicon level, post-silicon level and the like.

The verification is performed on the device to assess that requirements are met, pass/fail all or portions of the device, identify failures, determine causes of failure, determine root causes of failure, characterize the device, predict behavior, predict behavior for untested scenarios and the like.

Devices continue to increase in performance, complexity, provided features and the like. As a result, the verification also increases in complexity. For example, the number of requirements, characterization and the like also increases in complexity.

Factors that impact the performance of devices are typically identified and tested to facilitate verification. The performance includes one or more responses. The factors that impact the performance of devices include, for example, input stimuli, device parameters, system parameters, production process variation, operating conditions, tool variations and the like. As the complexity of devices increases, so do the number of factors that can impact performance. These factors are referred to as performance factors. For example, a given device can have a thousand or more performance factors.

It is appreciated that testing for all possible performance factors could be cost prohibitive. Thus, an analysis, referred to as sensitivity analysis, is performed to identify a smaller set of more relevant factors. Sensitivity analysis includes the study of how the uncertainty in the output of a mathematical model or system (numerical or otherwise) can be apportioned to different sources of uncertainty in its inputs. Once the analysis is performed, verification, including characterization, is performed using the smaller or reduced set of factors thereby allowing verification to be performed with reduced complexity and within a suitable time.

A technique for performing sensitivity analysis using entropy is described. The technique facilitates identification of the more relevant factors by identifying which factors the response is generally independent of and which factors the response is dependent upon. The independent factors generally have a distribution where the response is substantially independent of the independent factors. A factor that has no impact on a response has a distribution that is independent of the distribution of the response and is substantially independent of the response. A factor that has an impact on a response and a distribution that is dependent of the response is substantially dependent on the response.

By identifying the more relevant factors, the number of measurements and/or simulation runs needed for verification of a system is reduced. The identification of causes of failures is facilitated. Requirements, such as critical responses, are strongly related to the more relevant factors and can, as a result, be identified and causes of failures identified.

Some other sensitivity analysis techniques include a one factor at a time (OAT) approach, variance based methods, linear regression and classical approaches. In the OAT approach, each factor is varied in turn while the rest of the factors are maintained at a fixed value. Generally, each factor is tested with a limited number of samples. This approach can identify the impact of individual factors. However, this approach does not consider interactions between factors. Additionally, the accuracy in determining the impact of each factor is typically low due to limited number of samples.

The variance based methods attempt to determine the amount of variation in a response caused by each factor. This is obtained using special experiment plans where these/those factors are changed after a predetermined pattern for each run, whether a simulation or measurement. The patterns are selected so that the decomposition of the effects of different factors is possible. However, the variance based methods require a relatively high number of runs, impose an experiment plan that is only useful for a particular analysis and the factors need to be orthogonal (i.e., no correlation can be induced).

The linear regression approach aims as estimating a relationship/law between a response and the factors. To determine the relationship, statistical linear regression is used. Once the relationship is determined with suitable confidence, a deeper analysis can be performed. However, this approach is based on finding an appropriate function to fit the relationship and the accuracy of the fit. A lack of fitness is common.

The classical approaches include a number of approaches. An analysis of variance (ANOVA) approach requires a high number of runs, huge computation power and its own experimental plan. A correlation method is based on linear correspondence of a response with factors. The correlation method only detects linear effects. Matrix scatter plots are another approach and can reveal factor-response relationship, but require human intervention to judge impact of the factors on the response.

There are several disadvantages of the other approaches. They require a large number of evaluations, which is dependent on the number of factors. The approaches only account for a limited number of effects, such as linear or first order effects. They impose their own design of experiment; the simulated/measured results can only be used for the particular approach.

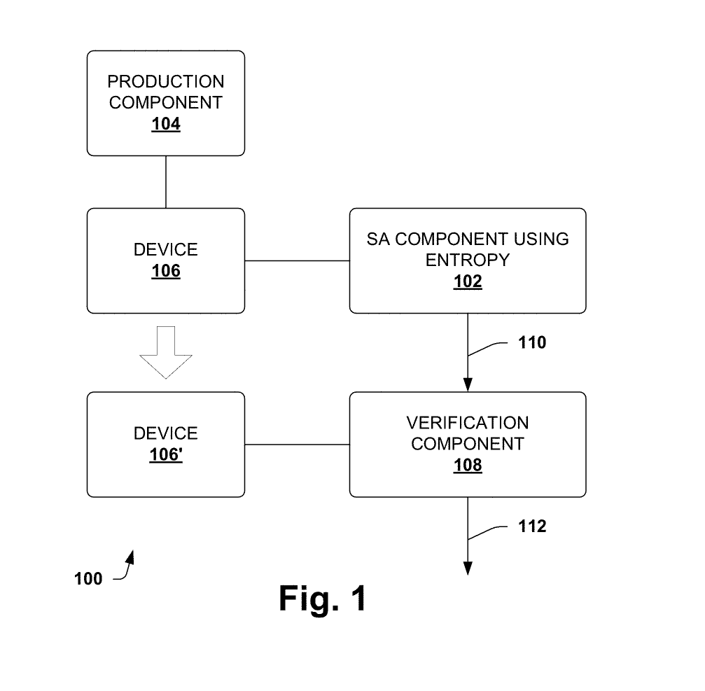

FIG. 1 is a block diagram illustrating a device production and verification system 100. The system 100 performs sensitivity analysis using entropy. The sensitivity analysis identifies a set of more relevant factors that are used for verification.

The system 100 includes a sensitivity analysis component 102, a production component 104, and a verification component 108. The system 100 operates or acts on a device 106. The device 106 includes semiconductor based devices or chips at various stages of fabrication, including at completion. The device 106 can be incorporated or used in systems, such as automotive systems, computer systems and the like.

The production component 104 includes tools, equipment and the like utilized to fabricate the device 106. In one example, the production component 104 includes fabrication tools for performing one or more semiconductor fabrication processes. In another example, the production component 104 includes electronic design and automation (EDA) tools.

The verification component 108 is configured to perform verification testing on the device 106′ using a reduced set of relevant factors 110. The verification component 108 is configured to generate test results 112 based on the verification testing of the device 106. The reduced set of relevant factors 110 facilitate performing the verification testing in a suitable or reasonable time period with a reduced complexity while obtaining the tests results 112 that verify performance based on the relevant factors 110.

The device 106 has one or more responses based on a relatively high number of factors. The responses can include, for example, output voltage, maximum output voltage, chip temperature, maximum output current, switching delay, slew rate, analog to digital conversion error and the like. Each response varies according to the factors. For example, a response of an output voltage can have different values, referred to as response values, based upon the factors, such as an input voltage, temperature, and the like. The relatively high number of factors can number in the thousands, as an example. The factors can include input stimuli, process variations, operating conditions, design parameters and the like.

The factors and responses can be related to or associated with a variety of applications including, for example, a voltage regulator that provides power for various loads, a voltage regulator that provides power to automotive loads, a processor or circuitry in automotive electronics, a processor or circuitry located on a credit card, a switch that drives a valve in an anti-lock braking system (ABS), a switch that drives an electric motor, a pressure sensor, a pressure sensor for an airbag system, a current sensor, a current sensor in an electrical power steering (EPS) system and the like. It is appreciated that the factors and responses can also be related to or associated with other applications.

Each response varies according to changing values of the factors. However, some of the factors have a larger role in a given response than others. Additionally, some factors can act together. While still other factors have a relatively small or no impact on the given response.

The sensitivity analysis component 102 is configured to determine or identify the reduced set of relevant factors 110 that impact a response using entropy. The reduced set 110 is typically substantially smaller than all the possible factors. For example, the reduced set 110 may include 5 factors whereas the number of possible factors is over 1,000. The reduced set 110 is determined for a type of design or experiment, such as a pass fail type or qualification type.

The sensitivity analysis component 102 is configured to perform sensitivity analysis on the device 106 using entropy to determine the reduced set of relevant factors 110. The reduced set 110 provides the substantial variation in the response.

In one example, the sensitivity analysis component 102 is configured to generate a set of entropy values for the set of factors. The sensitivity analysis component 102 uses the set of entropy values to determine the reduced set 110.

Additionally, the performed sensitivity analysis reduces the verification space (numbers of factors), provides failure discovery, provides effect discovery, provide an increased understanding of the device 106 and the like.

The relationship between the response and factors is also referred to as a response-factors function. Factors that the response is generally independent of are referred to as independent factors. Factors that the response is generally or substantially dependent on are referred to as dependent factors. Thus, the independent factors means that the response is independent or not substantially impacted by a distribution of values for the factors. The factors determined to be independent are omitted from the reduced set of relevant factors 110. The sensitivity analysis component 102 can also be configured to determine weights for dependent factors and/or factor combinations. The response-factors function represents or estimates an actual response-factor function. The response-factors function can be provided with the reduced set of relevant factors 110.

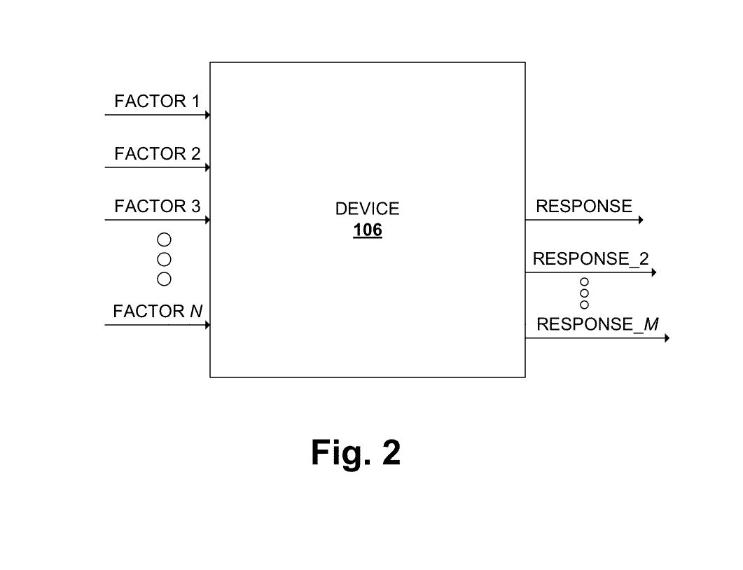

FIG. 2 is a diagram illustrating a device 106 subjected to sensitivity analysis using local gradients. The device 106 is provided as an example and it is appreciated that other suitable devices can be employed.

The device 106 includes semiconductor based devices or chips at various stages of fabrication, including at completion. The device 106 can be incorporated or used in systems, such as automotive systems, computer systems and the like.

The device 106 is shown with N possible factors one or more responses M or a set of responses. The factors can include input stimuli, process variations, operating conditions, design parameters and the like. The response can include, for example, output voltage, maximum output voltage, chip temperature, maximum output current, switching delay, slew rate, analog to digital conversion error and the like. The number N can be relatively large, such as N=100, N=1,000 and the like. The response values for each response vary based on changes to the factors.

As shown above, the sensitivity analysis component uses entropy to determine which factors and/or combinations of factors the response is dependent or independent of. The dependent factors or combination of factors, which are the factors the response is dependent on are identified and used as a reduced set of relevant factors.

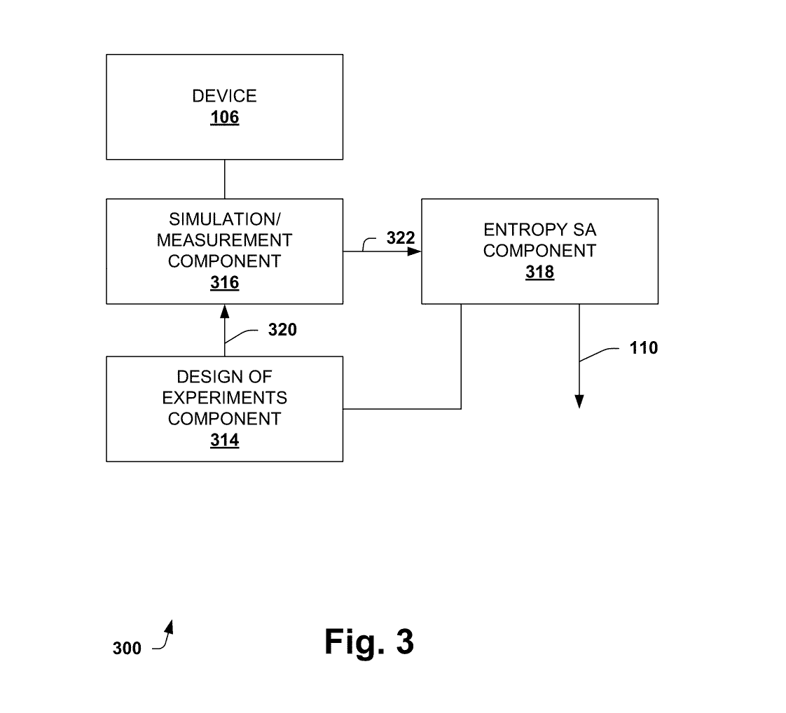

FIG. 3 is a block diagram of a sensitivity analysis arrangement 300 using entropy. The arrangement 300 is provided as an example of a suitable sensitivity analysis component that can be used as the component 102 in the system 100 and in other aspects or embodiments. It is appreciated that variations in the arrangement 300, including or omitting components, is contemplated.

The arrangement 300 includes a design of experiments (DoE) component 314, a simulation/measurement component 316 and a sensitivity analysis entropy controller 318. The arrangement 300 operates on devices, such as the device 106, to identify a reduced set of relevant factors 110 that can be used for verification and/or characterization.

It is appreciated that the components of the arrangement 300 can be combined into single components and/or their functionality placed in other components.

The DoE component 314 is configured to determine a set of factors or varying factors for a response. The set of factors can include all possible factors. The DoE component 314 is also configured to select a design of experiments for the set of factors. Each of the set of the design of experiments includes values or ranges for individual factors of the set of factors and the like. For example, a factor based on an input signal can be set to vary from 0 to 5 volts. In one example, a matrix of various values for the factors is generated as the selected set of design of experiments.

The simulation component 316 is configured to simulate or measure response values of a response for each of the factors and the selected set of design of experiments. The response values, also referred to as samples or values, can be arranged in a matrix or other suitable data structure. In one example, the responses are generated by simulation using a model representing behavior of a device. In another example, the responses are measured using one or more devices wherein inputs are applied to the device according to the selected set of design of experiments.

The SA entropy component 318 is configured to use entropy to generate a reduced set of relevant factors 110 and a response-factors function based on the responses or samples provided by the simulation/measurement component 316. The reduced set of factors 110 is a subset of the possible or initial factors. The component 318 can include a controller, logic and/or circuitry to generate the reduced set of factors 110.

The SA component 318 uses qualitative measures and/or a systematic structure to determine the dependence of the factors on the response. An example of a qualitative measure is to generate scatter plots that illustrate the impact the factors have on the response. The scatter plots can show a hint of correlation or dependency between a factor and a response. If the points are randomly spread out across a range, it implies that that factor does not influence the response.

The SA component 318, in one example, is configured to determine a set of entropy values for the set of factors. Additionally, the SA controller 318 is configured to determine the reduced set of relevant factors based on the set of entropy values. It is also noted that the arrangement 300 is described with regard to a response, however it is appreciated that the arrangement can be extended to determine reduced sets of relevant factors for a plurality of different responses.

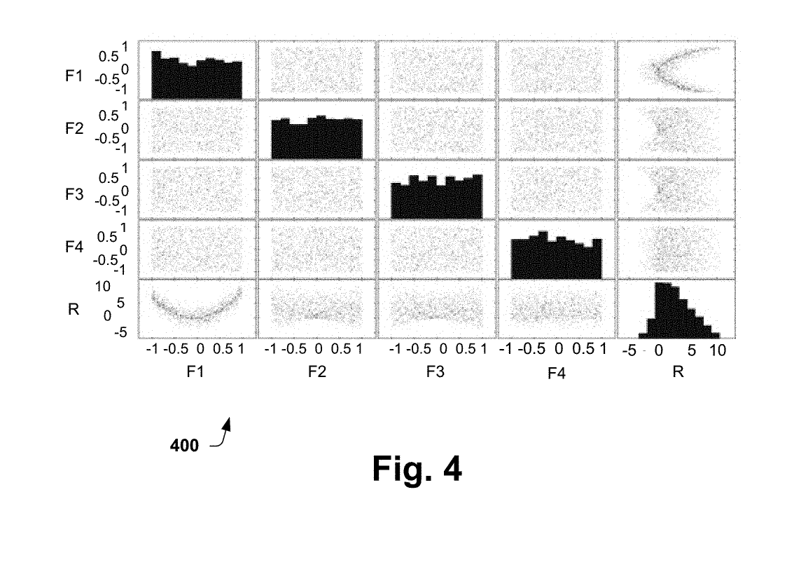

FIG. 4 is a graphic 400 of scatter plots showing response values or samples for various factors and their relationship. The graphic 400 is provided as an example for illustrative purposes. It is appreciated that other numbers of factors and response-factors functions can be estimated and/or determined.

FIG. 4 shows factors F1, F2, F3 and F4 and corresponding response values R. These values are shown along an x-axis and a y-axis. Scatter plots are shown that illustrate the impact of a factor on another factor or the response R.

For example, a scatter plot between F1 and R shows that the response values appear to be impacted by changes in factor values for F1. Thus, R is dependent on F1. As another example, a scatter plot between F4 and R shows that the response values are not impacted by changes in factor values for F4. Thus, R is substantially independent of F4.

A mathematical example of a suitable technique that can be used by the SA controller 318 and other aspects or embodiments is disclosed. A device is characterized by a response or response variable denoted by Y. The response variable Y is given by:

Y=f(X₁, . . . ,X_{K})+ε

Where there are K input factors X. Random error is represented by ε, which is typically present in measurements, but not simulations.

The goal is to find the set of k subfactors {X₁, . . . , Xₖ} that have the greatest impact on Y.

In order to simplify the understanding of the method the scatter plots shown in FIG. 4 are used to illustrate the impact that factors have on the response. The dependency of response R on factors (F), also referred to as the response-factors function is given below.

R=8F₁²+F₁−4F₂F₃

For the example shown in FIG. 4, there is only a relatively small number of scatter plots to review. For this small number, the scatter plots can be reviewed and relationships or impact estimated. However, typical devices can include thousands or more factors for a particular response. In order to judge for all the factors and all the responses, one has to look at thousands of such scatter plots, which makes the approach impracticable.

Instead of reviewing scatter plots, a systematic structure that determines a measure of randomness or uncertainty is described. This approach is referred to as entropy or statistical entropy. An equation for determining entropy H is provided:

$$H ( Y ) = \{ \begin{matrix}- \int f ( y ) ln ( f ( y ) ) dy , if the distribution of Y is continuous , \\ - Σ {p}_{i} ln ( {p}_{i} ) , if the distribution of Y is discrete ,\end{matrix}$$

where f (y) is a probability density function; pᵢ=P(Y>Yᵢ) where pᵢ=P(YεIᵢ); and Iᵢ is the bin.

The entropy Has an objective measure of randomness of a system. The following properties are evident based on the above equation:

H is a positive function of {pᵢ}.

H=0 if one outcome has probability of 1.

H gets the maximum value when the outcomes are equally likely.

Additionally, the entropy H can be calculated for joint probability distributions, meaning the response against one or many factors. The calculation of pᵢ will change to: pᵢ=P(Y>Yᵢ, X>Xᵢ) and so on, where pᵢ=P(YεIᵢ); and Iᵢ is the bin.

A third property of the entropy H is that it gets the maximum value when there is total randomness, i.e. factor Xᵢ has no impact on Y. In general, an increase in entropy His caused by an increase in randomness or disorder. This link can be made rigorous and is useful, as this may characterize the influence of a factor on the output response R. Therefore, factors that yield lower entropy have greater impact on the response than factors with higher entropy.

Based on the above, there are two entropy-based techniques, simple and pair. The simple entropy technique analyzes factors individually whereas the pair entropy approach analyzes multiple or combined factors. The term evaluation run or run implies a measurement or simulation of factor values for a device that provides response values for a response.

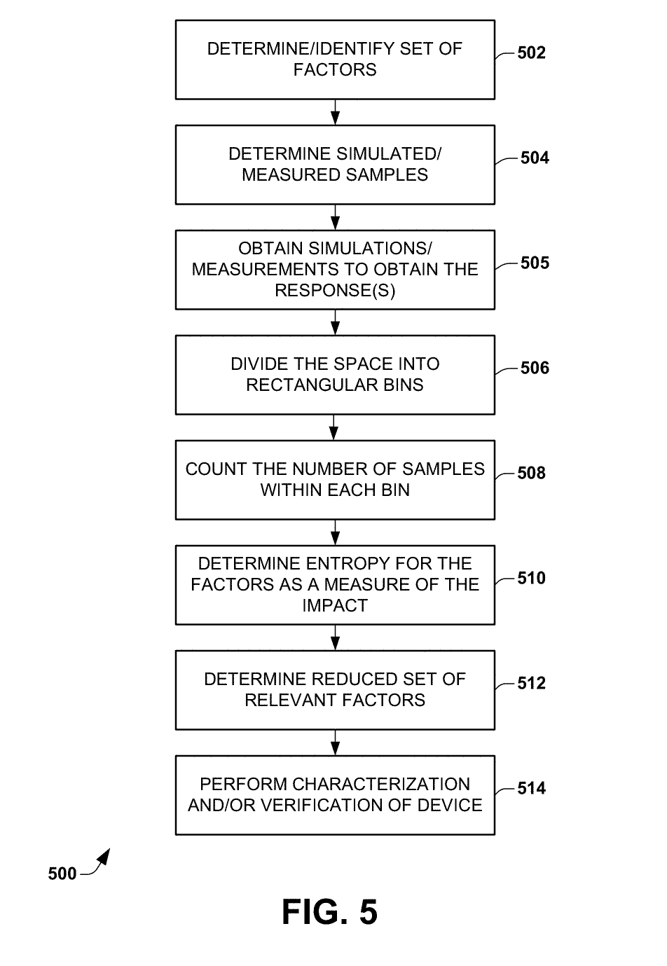

FIG. 5 is a flow diagram illustrating a method 500 of determining a reduced set of relevant factors for a response by performing sensitivity analysis using a simple entropy technique. The sensitivity analysis generates a measure of entropy, which is then used to determine which factors to include in a reduced set of relevant factors.

A set of varying factors {X₁, . . . , X_{K}} associated with a system/device are determined at block 502. Additionally, a design of experiments is selected, using the set of varying factors. The design of experiments can be selected based on previous knowledge about the device. Further, the design can be based on a type, such as a qualification or pass fail test. In one example, a Monte Carlo (MC) approach is used where the factors take random values uniformly distributed from their allowed interval.

The device includes semiconductor based devices or chips at various stages of fabrication, including at completion. The device can be incorporated or used in systems, such as automotive systems, computer systems and the like. The factors can include input stimuli, process variations, operating conditions, design parameters and the like.

In one example, the design of experiments component 314 or variations thereof is configured to determine the set of varying factors and select the design of experiments.

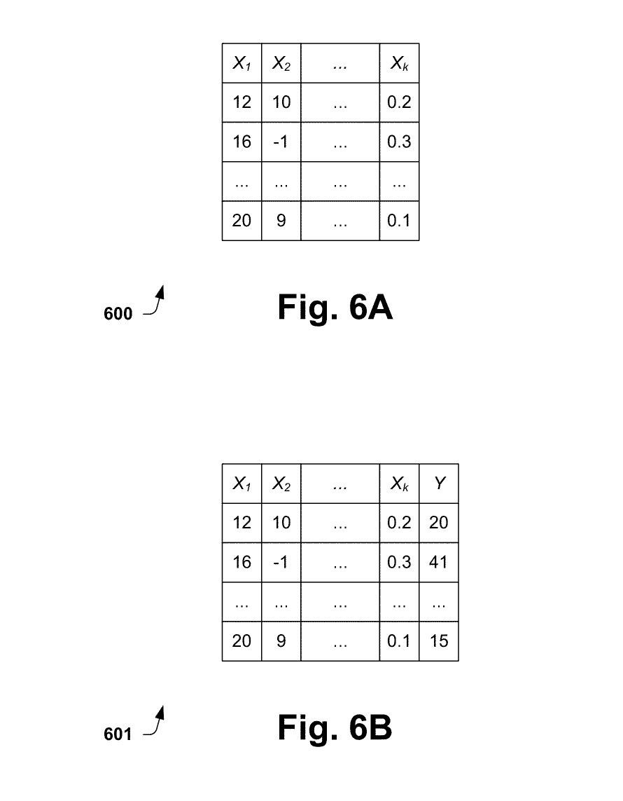

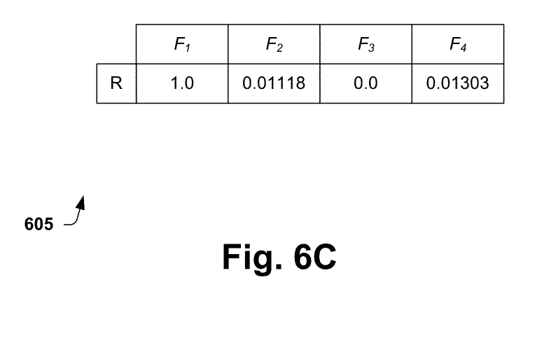

FIG. 6A is a table 600 illustrating an example of a design of experiments that can be developed using the block 502 of the method 500. The table 600 is provided for illustrative purposes. The table 600 has K factors with various sets of factor values arranged in rows. The design of experiments is shown with values and a number of sets of factor values for illustrative purposes. It is appreciated that the design of experiments can include other values, omit sets, and/or include additional sets of factor values.

Simulations or measurements are determined using the selected design of experiment to generate response values for a response at block 504. The set of factor values is determined at block 502 and the factor values are used to generate the response or the response values based on the factor values. The response is generated via simulation or by measurement and includes a plurality of responses or response values, also referred to as samples.

The response can include, for example, output voltage, maximum output voltage, chip temperature, maximum output current, switching delay, slew rate, analog to digital conversion error and the like. Each response value varies according to the set of factor values.

Additionally, the simulations or measurements can be performed or repeated for additional responses.

In one example, the simulation component 316 is configured to generate the response values by simulation and/or measurement.

FIG. 6B is a table 601 illustrating an example of simulations for a design of experiments for a response that can be developed using the block 504 of the method 500. The table 601 is provided for illustrative purposes. The table 601 also has K factors with various sets of factor values arranged in rows and a corresponding response value Y. It is appreciated that the design of experiments can include other values, response values, omit sets, and/or include additional sets of factor values.

Rectangular bins are created for the factors at block 506. In one example, for each factor Xi, a space defined by (Y, Xi) is divided into a bin rectangle, where Y represents simulated or measured response values/samples for that factor. The edges of each bin are the quantiles of distributions of Y and Xi. For example, if a space is 10 by 10, the edges of the bins will be the (multiples of 10)-quantiles of distribution Y and 10-quantiles of distribution Xi.

Additional simulations/measurements can be obtained at block 505 to obtain the response value and/or additional response values.

The size of each bin can vary. In one example, the size is selected to include a sufficient average number of samples, such as greater than or equal to 20.

The number of response values or samples that fall into the bins are counted at block 508. Thus, for each bin (b) a sum based on a total number of evaluation runs is determined. The sum m_{b} is referred to as a bin count.

N=Σ_{b=1}^{B}m_{b}

where m_{b} represents the number of points falling in the b^{th} bin, N is the total number of runs and B is the total number of bins.

Entropy values for the factors are determined at block 510. The entropy His a measure of disorder and determines the impact of a factor Xi on the response Y. The entropy for each factor can be determined using the below equation for a relation between a current factor Xi and the response Y:

$${H}_{i} = {Σ}_{b = 1}^{B} \frac{{m}_{b}}{N} log ( \frac{{m}_{b}}{N} )$$

where Hᵢ is the entropy for factor Xi.

Entropy or entropy values are determined for each factor 1-K using the above equation to generate a set of entropy values {H₁, . . . , H_{K}}.

As stated above, the smaller or lower the entropy value, the greater the impact of Xi on Y.

A reduced set of relevant factors is determined at block 512 according to the set of entropy values. In example, the factors are determined based on having entropy values below a threshold. In another example, a number or percentage of factors having the most impact on the response Y are selected. The reduced set can include factors {X₁, . . . , Xₖ}, where k is the number of factors in the reduced set of relevant factors.

Additionally, the entropy values associated with the reduced set of relevant factors can be used to determine weighting for each of the factors.

FIG. 6C is a table 605 illustrating an example of entropy values. In this example, there are four factors shown and associated effects. A relatively small number of factors are shown in order to facilitate understanding. It is appreciated that much larger number of factors can be utilizes, such as in the hundreds.

Factor F1 has the highest entropy value at 1.0, and is thus, independent of the response R. Factor F3 has the lowest entropy at 0.0, thus F3 impacts R. Factors F2 and F3 have relatively small values and are also considered to impact R. In this example, the factors F2, F3, and F4 are included in the reduced set of relevant factors.

Verification and/or characterization of a device is performed at block 514. The verification is performed using the reduced set of relevant factors generated at block 512. The verification can also be performed on one or more additional devices.

The verification can indicate, for example, whether the subject device meets operating requirements, has defects, fails requirements, and the like. The reduced set of relevant factors also facilitates identification of causes of defects or failures.

It is appreciated that variations of the method 500 are contemplated, such as including functionality and features of the above described arrangements and systems.

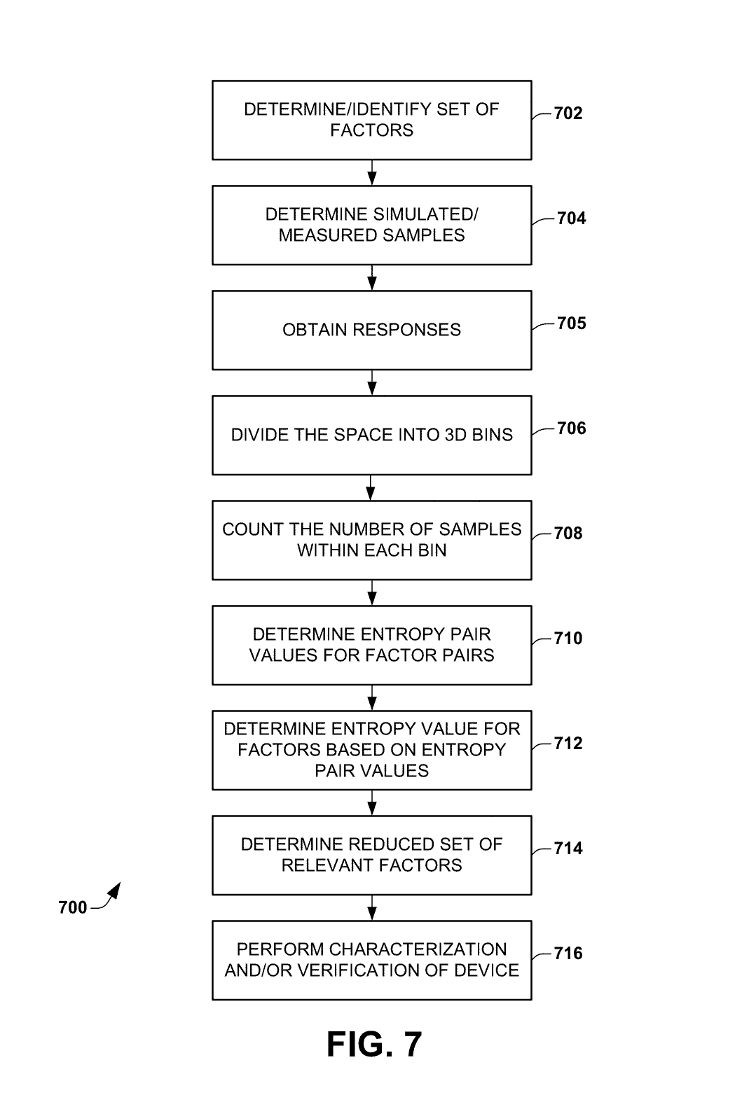

FIG. 7 is a flow diagram illustrating a method 700 of determining a reduced set of relevant factors by performing sensitivity analysis using a pair based entropy technique. The sensitivity analysis generates a measure of entropy, which is then used to determine which factors to include in a reduced set of relevant factors. The method 700 is similar to the method 500, which can be referenced for additional description. However, the method 700 is more efficient in discovering interactions among factors.

A set of varying factors {X₁, . . . , X_{K}} associated with a response and a system/device are determined at block 702. Additionally, a design of experiments is selected, using the set of varying factors.

The device includes semiconductor based devices or chips at various stages of fabrication, including at completion. The device can be incorporated or used in systems, such as automotive systems, computer systems and the like. The factors can include input stimuli, process variations, operating conditions, design parameters and the like.

In one example, the design of experiments component 314 or variations thereof is configured to determine the set of varying factors and select the design of experiments.

Simulations or measurements are determined using the selected design of experiment to generate a response at block 704. The response includes samples or response values. The set of factors values is determined at block 702 and the factor values are used to generate a response based on the factor values. The response is generated via simulation or by measurement and includes a plurality of responses or response values.

The responses can include, for example, output voltage, maximum output voltage, chip temperature, maximum output current, switching delay, slew rate, analog to digital conversion error and the like. Each response varies according to the set of factor values.

Additional simulations and/or measurements can be performed at block 705 to obtain the response value(s) for additional responses.

In one example, the simulation component 316 is configured to generate the response values by simulation and/or measurement.

Three dimensional (3D) bins are created for pairs of factors and response value(s) at block 706. In one example, each pair includes factors Xi and Xj. The pair and response occupy a three dimensional space (Xi, Xj, Y). This space is divided into bins, which are in the form of rectangular prisms, whose edges are the quantiles of the factors and of the response.

The size of each bin can vary. In one example, the size is selected to include a sufficient average number of samples/response values, such as greater than or equal to 20.

The number of response values or samples that fall into the bins are counted at block 708. Thus, for each bin (b) a sum based on a total number of evaluation runs is determined. m_{b} is referred to as a bin count.

N=Σ_{b=1}^{B}m_{b}

where m_{b} represents the number of points falling in the b^{th} bin, N is the total number of runs and B is the total number of bins.

Entropy pair values for the factor pairs are determined at block 710. The entropy H for the factor pairs is a measure of disorder and determines the impact of a factor pair Xi, Xj on the response value Y. A pair entropy value Hᵢⱼ is calculated for each factor pair (Xᵢ, Xⱼ). The pair entropy values are combined into a K×K matrix (where K is the total number of factors), which is symmetrical (Hᵢⱼ=Hⱼᵢ). The pair with the lowest entropy has the greatest impact on Y.

Entropy values for individual factors are determined from the entropy pair values at block 712. The impact of an individual factor Xi can be derived from the pair entropy values:

Ĥᵢ=minᵢ(Hᵢⱼ),j=1̅,̅N̅

Entropy or entropy values are determined for each factor 1-K using the above equation to generate a set of entropy values {Ĥ₁, . . . , Ĥ_{K}}.

As stated above, the smaller or lower the entropy value, the greater the impact of Xi on Y.

A reduced set of relevant factors is determined at block 714 according to the set of entropy values. In example, the factors are determined based on having entropy values below a threshold. In another example, a number or percentage of factors having the most impact on the response Y are selected. The reduced set can include factors {X₁, . . . , Xₖ}, where k is the number of factors in the reduced set of relevant factors.

Verification and/or characterization of a device is performed at block 716. The verification is performed using the reduced set of relevant factors generated at block 714. The verification can also be performed on one or more additional devices.

The verification can indicate, for example, whether the subject device meets operating requirements, has defects, fails requirements, and the like. The reduced set of relevant factors also facilitates identification of causes of defects or failures.

It is appreciated that variations of the method 700 are contemplated, such as including functionality and features of the above described arrangements and systems. Further, portions of the method 700 can be repeated for the additional responses to obtain additional reduced sets of relevant factors for the additional responses.

While the method is illustrated and described below as a series of acts or events, it will be appreciated that the illustrated ordering of such acts or events are not to be interpreted in a limiting sense. For example, some acts may occur in different orders and/or concurrently with other acts or events apart from those illustrated and/or described herein. In addition, not all illustrated acts may be required to implement one or more aspects or embodiments of the disclosure herein. Also, one or more of the acts depicted herein may be carried out in one or more separate acts and/or phases.

In this regard, while the disclosed subject matter has been described in connection with various embodiments and corresponding Figures, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

In particular regard to the various functions performed by the above described components or structures (assemblies, devices, circuits, systems, etc.), the terms (including a reference to a “means”) used to describe such components are intended to correspond, unless otherwise indicated, to any component or structure which performs the specified function of the described component (e.g., that is functionally equivalent), even though not structurally equivalent to the disclosed structure which performs the function in the herein illustrated exemplary implementations of the invention. In addition, while a particular feature may have been disclosed with respect to only one of several implementations, such feature may be combined with one or more other features of the other implementations as may be desired and advantageous for any given or particular application.

It is appreciated that the claimed subject matter may be implemented as a method, apparatus, or article of manufacture using standard programming and/or engineering techniques to produce software, firmware, hardware, or any combination thereof to control a computer to implement the disclosed subject matter (e.g., the systems, arrangements and the like shown in FIGS. 1, 2, etc., are non-limiting examples that may be used to implement the above methods). The term “article of manufacture” as used herein is intended to encompass a computer program accessible from any computer-readable device, carrier, or media. Of course, those skilled in the art will recognize many modifications may be made to this configuration without departing from the scope or spirit of the claimed subject matter.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form.

In addition, the articles “a” and “an” as used in this application and the appended claims should generally be construed to mean “one or more” unless specified otherwise or clear from context to be directed to a singular form.

A sensitivity analysis arrangement using entropy is disclosed. The arrangement includes a design of experiments component, a simulation component and an entropy SA component. The design of experiments component is configured to generate a set of factors of a response for a device and to generate a design of experiments using the set of factors. The simulation component is configured to obtain response values for the design of experiments and the set of factors. The entropy controller is configured to determine a set of entropy values for the set of factors and to determine a reduced set of relevant factors based on the set of entropy values. The reduced set of relevant factors is a subset of the factors.

A sensitivity analysis and verification arrangement is disclosed. The arrangement includes a sensitivity analysis component and a verification component. The entropy sensitivity analysis component configured to generate a set of entropy values for a set of factors and to use the set of entropy values to generate a reduced set of relevant factors from the set of factors. The verification component is configured to perform verification using the reduced set of relevant factors.

A method of performing sensitivity analysis using entropy is disclosed. A set of factors are determined for a device. A design of experiments is selected for the set of factors and the device. The design of experiments includes sets of factor values. Samples for the design of experiments are obtained. The samples are response values based on the sets of the factor values. A plurality of bins are created for the set of factors. A plurality of bin counts are determined for the plurality of bins. A set of entropy values are determined based on the plurality of bin counts.

In particular regard to the various functions performed by the above described components or structures (assemblies, devices, circuits, systems, etc.), the terms (including a reference to a “means”) used to describe such components are intended to correspond, unless otherwise indicated, to any component or structure which performs the specified function of the described component (e.g., that is functionally equivalent), even though not structurally equivalent to the disclosed structure which performs the function in the herein illustrated exemplary implementations of the invention. In addition, while a particular feature of the invention may have been disclosed with respect to only one of several implementations, such feature may be combined with one or more other features of the other implementations as may be desired and advantageous for any given or particular application. Furthermore, to the extent that the terms “including”, “includes”, “having”, “has”, “with”, or variants thereof are used in either the detailed description and the claims, such terms are intended to be inclusive in a manner similar to the term “comprising”.

What is claimed is:

1. A sensitivity analysis arrangement using entropy comprising:
a design of experiments component configured to generate a set of factors of a response for a device and to generate a design of experiments using the set of factors;
a simulation/measurements component configured to obtain response values for the design of experiments and the set of factors; and
an entropy SA component configured to determine a set of entropy values for the set of factors and to determine a reduced set of relevant factors based on the set of entropy values, where the reduced set of relevant factors is a subset of the factors.

2. The arrangement of claim 1, wherein the set of factors includes input process variations, and operating conditions.

3. The arrangement of claim 1, wherein the response is one of an output voltage, an output current, and chip temperature.

4. The arrangement of claim 1, the set of entropy values provide a measure of the impact of the factors on the response.

5. The arrangement of claim 1, wherein the reduced set of relevant factors is about 1/20 of the size of the set of factors.

6. The arrangement of claim 1, wherein the design of experiments includes a plurality of factors and a plurality of sets of factor values.

7. The arrangement of claim 1, wherein the simulation component is configured to measure the response values of the device.

8. The arrangement of claim 1, wherein the simulation component is configured to obtain the response values by simulation of a model of the device.

9. The arrangement of claim 1, wherein the entropy controller is configured to create a plurality of bins for the set of factors and count the response values within each bin, wherein the count for each bin is utilized by the entropy controller to determine the set of entropy values.

10. The arrangement of claim 9, wherein each bin is based on a single factor of the set of factors.

11. The arrangement of claim 9, wherein each bin is based on a pair of factors of the set of factors.

12. The arrangement of claim 11, wherein the entropy controller is configured to determine a matrix of entropy pair values using the bins and to determine the set of entropy values from the matrix of entropy pair values.

13. A sensitivity analysis and verification arrangement comprising:
an entropy sensitivity analysis component configured to generate a set of entropy values for a set of factors and to use the set of entropy values to generate a reduced set of relevant factors from the set of factors; and
a verification component configured to perform verification using the reduced set of relevant factors.

14. The arrangement of claim 13, wherein the performed verification includes pass/failure for device specifications.

15. The arrangement of claim 13, wherein the performed verification includes fault identification.

16. The arrangement of claim 13, wherein the entropy sensitivity analysis component is configured to create a bin for each factor of the set of factors and to use the plurality of bins to generate an entropy value for each factor of the set of factors.

17. The arrangement of claim 13, wherein the entropy sensitivity analysis component is configured to create a bin for each factor pair of the set of factors and use the plurality of bins to generate a matrix of entropy pair values and to use the matrix of entropy pair values to generate a set of entropy values for the set of factors.

18. A method of performing sensitivity analysis using entropy, the method comprising:
determining a set of factors for a device;
selecting a design of experiments for the set of factors, wherein the design of experiments includes sets of factor values;
obtaining samples for the design of experiments, wherein the samples are response values based on the sets of the factor values;
creating a plurality of bins for the set of factors;
determining a plurality of bin counts for the plurality of bins; and
determining a set of entropy values based on the plurality of bin counts.

19. The method of claim 18, further comprising determining a reduced set of relevant factors based on the set of entropy values.

20. The method of claim 18, further comprising determining a matrix of entropy pair values based on the plurality of bin counts and using the matrix of entropy pair values to determine the set of entropy values.
